(19) United States
(12) Patent Application Publication
(10) Pub. No.: US 2020/0167657 A1
(43) Pub. Date: May 28, 2020

(54) TRAINING APPARATUS, TRAINING METHOD, NON-TRANSITORY COMPUTER READABLE MEDIUM, AND MODEL GENERATING METHOD

(71) Applicant: Preferred Networks, Inc., Tokyo-to (JP)

(72) Inventors: Seiya TOKUI, Tokyo-to (JP); Daisuke NISHINO, Tokyo-to (JP); Hiroyuki Vincent YAMAZAKI, Tokyo-to (JP); Naotoshi SEO, Tokyo-to (JP); Akifumi IMANISHI, Tokyo-to (JP)

(73) Assignee: Preferred Networks, Inc., Tokyo-to (JP)

(21) Appl. No.: 16/693,754

(22) Filed: Nov. 25, 2019

(30) Foreign Application Priority Data
Nov. 26, 2018 (JP) 2018-220606
Nov. 19, 2019 (JP) 2019-209063

(51) Int. Cl. G06N 3/08; G06N 3/04

(52) U.S. Cl. CPC G06N 3/084; G06N 3/04

(57) ABSTRACT

A training apparatus includes one or more memories and one or more processors. The one or more processors are configured to generate a graph based on a path of an error backward propagation, assign an identifier to each node based on the path of the error backward propagation in the graph, and execute the error backward propagation based on the graph and on the identifier.

### CROSS REFERENCE TO RELATED APPLICATIONS

This application claims benefit of and priority to Japanese Patent Application No. 2018-220606, filed on Nov. 26, 2018, and Japanese Patent Application No. 2019-209063, filed on Nov. 19, 2019, the entire contents of which are incorporated herein by reference.

### FIELD

The embodiments described herein relate to a training apparatus, a training method, a non-transitory computer readable medium, and a model generating method.

### BACKGROUND

In machine learning, a neural network model can express the transition of data from an input layer to an output layer as a graph, and can be trained by performing forward propagation and backward propagation based on the connections of the graph. There is, for example, a Define-by-Run scheme defining the network during execution of the training as a construction of the network. In the Define-by-Run scheme, since the shape of the graph changes during the training, a graph indicating processing on data can be formed during the forward propagation, and the backward propagation can be performed using the graph. As a result, a considerable space for storing the graph may become necessary and reduce an available memory area, resulting in difficulty in efficiently training the network in some cases.

### BRIEF DESCRIPTION OF THE DRAWINGS

FIG. 1 is a block diagram illustrating functions of a training apparatus according to some embodiments;

FIG. 2 is a chart illustrating an example of graph generation according to some embodiments;

FIG. 3 is a flowchart illustrating processing of the training apparatus according to some embodiments;

FIG. 4 is a chart illustrating an example of the graph generation according to some embodiments;

FIG. 5 is a chart illustrating an example of the graph generation according to some embodiments;

FIG. 6 is a chart illustrating an example of the graph generation according to some embodiments;

FIG. 7 is a chart illustrating an example of the graph generation according to some embodiments;

FIG. 8 is a chart illustrating an example of the graph generation according to some embodiments; and

FIG. 9 is a diagram illustrating a hardware implementation example of the training apparatus according to some embodiments.

### DETAILED DESCRIPTION

According to some embodiments, a training apparatus may include one or more memories and one or more processors. The one or more processors may be configured to generate a graph based on a path of error backward propagation, assign (apply) an identifier to each node based on the path of the error backward propagation in the graph, and execute the error backward propagation based on the graph and on the identifier.

Embodiments are explained below with reference to the drawings.

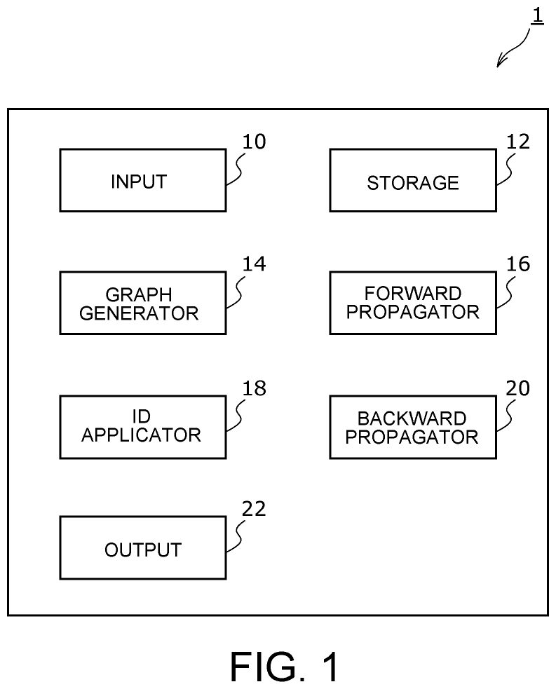

FIG. 1 is a block diagram illustrating functions of a training apparatus according to an embodiment. A training apparatus 1 includes an input 10 (input unit), a storage 12, a graph generator 14, a forward propagator 16, an ID applicator 18, a backward propagator 20, and an output 22 (output unit), and trains a learned model which outputs output data made by performing predetermined processing on input data.

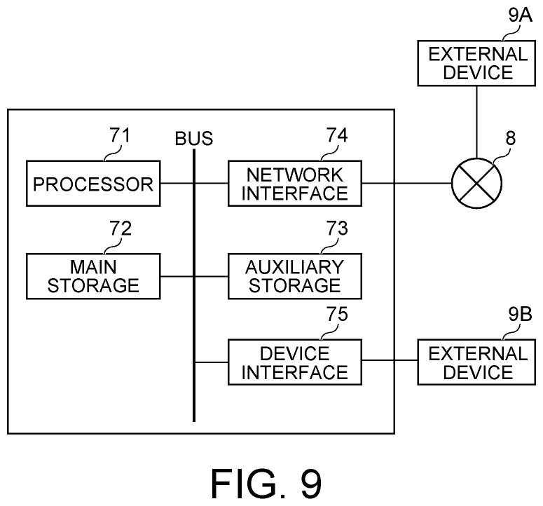

The input 10 may be an input device (see FIG. 9) configured to accept or receive input of data. The input data is, for example, data used for training or learning, such as training data which is data input into a network to be trained, teacher data or label data for use in calculation of a loss, and the like.

The storage 12 may store data used for the training in the training apparatus 1 or the result of the training. The storage 12 may store, for example, the configuration, parameters to be updated in the training and so on, concerning the network which is a training target. Further, the storage 12 may temporarily store the data input from the input 10. Further, the storage 12 may store final parameters after the training is finished. The training apparatus 1 may be configured to include the storage 12, but a part or the whole of the storage 12 may be provided outside the training apparatus 1 so that the training apparatus 1 can transmit and receive the data via a communication line or the like.

The graph generator 14 may generate an operation graph (a computational graph) at timing when data is input into the network. The forward propagator 16 may perform an operation on the input data based on a description of definition for forming the network. The description of the definition may be stored in the storage 12. As another example, a network definition descriptor which describes the definition for forming the network may be provided, and the graph generator 14 may generate the graph while executing forward propagation based on the definition of the network described in the network definition descriptor. As explained above, processing such as the forward propagation, the backward propagation and the like are not performed after a graph is generated in advance based on a predetermined network definition, but a graph is generated at timing of the forward propagation based on the description of the definition of the network as explained above, and subsequent processing is performed based on the generated graph. A different graph may be formed depending on, for example, the form of input/output variable or the like.

In the present embodiment, the graph generator 14 and the forward propagator 16 do not perform separate actions, but the forward propagator 16 executes the processing of the forward propagation while the graph generator 14 generates the graph, based on the structure of the network being the training target. In other words, for certain data or data group, the training apparatus 1 execute the forward propagation of the network based on each data and generate a graph for the backward propagation. As explained above, in the present embodiment, execution of the processing the forward propagation and subsequent to it is not performed after generation of a predetermined operation graph of the network, but a graph is generated every time an operation is performed with the input data together with the forward propagation processing, and then the subsequent processing (for example, the backward propagation) is executed.

The ID applicator 18 applies an identifier (hereinafter, described as a backward propagation ID) indicating a path of the backward propagation in the graph generated by the graph generator 14. For example, a backward propagation ID may be assigned to nodes of a graph to indicate a path of the backward propagation. In the case of following an operation path different for each variable contained in the data in the backward propagation, a backward propagation ID unique to each operation path may be applied to nodes included in the operation path such as a variable node and an operation node. For example, batches have variables of the same kind, a graph may be generated for each of the batches, and a backward propagation ID may be applied to each of the variables. The backward propagation ID may be uniquely applied for each graph.

The backward propagator 20 calculates a loss by comparing the result output from the forward propagator 16 after the forward propagation through the network with the teacher data (label data), and executes error backward propagation processing based on the loss. The backward propagation processing is executed for each backward propagation ID applied or generated by the ID applicator 18. The backward propagator 20 may delete the graph for which the backward propagation has been finished. The deletion may be performed by discarding or deleting the graph itself, or may be performed by substantially discarding the graph data by bringing the memory area or the like in which the graph is saved into a state of capable of overwrite save (for example, releasing or deallocating the memory). Further, in some embodiments, the backward propagator 20 does not execute the deletion of the graph, but a graph deleter (not illustrated) may be separately provided so that the graph deleter is configured to delete the graph based on the action of the backward propagator 20.

In the case of performing a batch operation, there is a case where variables of the same kind exist. In such a case, when there is such a condition that the operation paths are not different or differentiation is not performed two or more times in the variables of the same kind, a variable node and an operation node may be generated as a variable group to perform the operation using the same backward propagation ID.

After the action of the backward propagator 20 ends, if necessary, the above processing may be repeated by the graph generator 14, the forward propagator 16, the ID applicator 18, and the backward propagator 20 until the end condition of the training is satisfied, so as to further train the network.

The output 22 may be an output device (see FIG. 9) configured to output a learned model (trained model) after the training is ended. The output of the learned model may be implemented by outputting the whole model, or by outputting the data on the shape, parameters and the like regarding the model and outputting data capable of constructing the same learned model outside (e.g., outside the apparatus 1). In some embodiments, the learned model is not output to the outside via the output 22, but the learned model may be stored in the storage 12, in which case the training apparatus 1 which completes the training may be caused to function as an estimating apparatus or the like using the learned model.

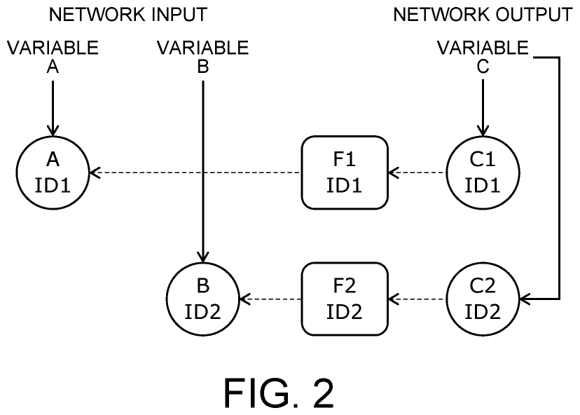

FIG. 2 is a chart illustrating an example of graph generation according to this embodiment. For example, a state in which variables A, B are input and a variable C is output (C=F(A, B)) is illustrated. Edges (broken lines) connecting nodes in each graph go from the output to the input, which illustrates the backward propagation, and during the forward propagation, transition between the nodes is made in the reverse direction. Note that the graph is indicated as a directed graph in this embodiment, but does not necessarily have to be the directed graph as long as it enables determination of the order of the backward propagation. For example, the graph may make an indication for following the nodes such that the operation is performed from the output to the input. In some embodiments, an array of operation nodes from the output toward the input may be stored, and the array of operation nodes may be sequentially executed.

When the variables A, B are input, processing of a function F may be performed to output the variable C. The processing may be executed by the forward propagator 16. In parallel with the processing of the forward propagation, the graph generator 14 may generate a graph. For example, the graph generator 14 may determine a path of the backward propagation at timing when the forward propagator 16 defines the processing of the function F, and, when there are a plurality of paths, the graph generator 14 may generate graphs corresponding to the paths. As a result, for example, when there are paths of the backward propagation for the respective variables A, B, a graph including a variable node A, a function operation node F1, and a variable node C1, and a graph including a variable node B, a function operation node F2, and a variable node C2 may be generated.

For each path of the backward propagation, the ID applicator 18 may apply the backward propagation ID for the graph. In FIG. 2, in the graph to which the variable node A, the operation node F1, and the variable node C1 belong, a backward propagation ID1 may be applied or assigned to each of the nodes. On the other hand, in the graph to which the variable node B, the operation node F2, and the variable node C2 belong, a backward propagation ID2 may be applied or assigned to each of the nodes. In some embodiments, the application of the backward propagation ID is not performed after the graph generation or in parallel with the graph generation, but there is a backward propagation ID and the graph generation may be performed based on the backward propagation ID. Also in this case, along with the graph generation, the ID applicator 18 may apply the backward propagation ID to each of the nodes constituting the graph.

Note that one operation node is illustrated for each graph for simplification of the explanation, but a graph composed of a plurality of consecutive operation nodes may be actually formed. Similarly in the following explanation, one operation node is illustrated for a graph, but two or more operation nodes may exist. In the forward propagation, an operation node may be generated for each operation requiring backward propagation so that the operation of the backward propagation is performed following each operation node. Further, regarding the input/output variable node connected to the operation node, input/output is not always performed for the first operation node (for example, an input layer) or the last operation node (for example, an output layer), but input/output may be performed for a middle node among the plurality of operation nodes. This relationship is equivalent to a relationship of the input/output of the variable to/from the network being the training target in the path of the backward propagation.

When there are a plurality of operation nodes, the above description also applies to the connection between the operation nodes, and when a certain function branches off to a plurality of other functions depending on the path of the backward propagation, a plurality of graphs to which different backward propagation IDs are applied may be generated. As explained above, a graph may be generated for each path of the backward propagation based on the variable and the function, the nodes belonging to the graph may be generated, and the backward propagation ID may be uniquely applied for the nodes in each graph.

The backward propagator 20 may perform the error backward propagation processing for each applied backward propagation ID to update the network. For example, by following the graph of the backward propagation ID1, the backward propagation may be executed for the parameter in the function F1 from the variable node C1 to update the parameter. In some embodiments, after all operations for the applied ID, for example, the backward propagation is performed to the variable node A, the information on the nodes with the backward propagation ID1 and the edge is discarded, and thereby the graph is discarded. Alternatively, in some embodiments, the graph may be discarded together with the information. As still another example, the backward propagator 20 may discard the information for each node at timing when it becomes unnecessary. Discarding the information for each node makes it possible to release the resource in use, at earlier timing.

At this stage, the graph to which the backward propagation ID2 is applied may still exist. Hence, the backward propagator 20 may execute, similarly in the above-explained manner, the error backward propagation on the nodes to which the backward propagation ID2 is applied to update the network.

As in the general machine learning, another variable may then be input to further update the network. In this case, a graph may be similarly generated for the input variable and subjected to the forward propagation, a backward propagation ID may be applied to the graph, and the graph becoming unnecessary may be automatically discarded while the backward propagation is being performed. Note that regarding the training, a method of the general machine learning can be used. As a matter of course, parallel processing can be performed using a mini batch or the like.

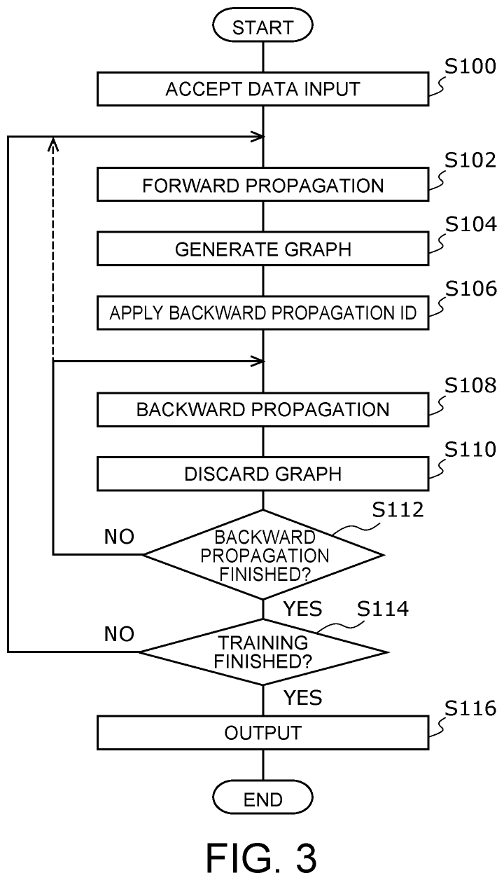

FIG. 3 is a flowchart illustrating the processing according to this embodiment.

First, input of data may be received or accepted via the input 10 (S100). Regarding the input of data, input of individual data may be accepted, or a predetermined number or a predetermined size of data may be accepted at a time. Besides, the acceptance of the input is not limited to the explicit input from the outside, but the input 10 may acquire the data stored in an external storage or the like to thereby accept the input or may acquire the data stored in the storage 12.

Next, the forward propagator 16 may forward propagate the input data (S102). By performing the forward propagation, an output may be acquired when the input data is input into the model being the learning target.

Next, the graph generator 14 may generate a graph (S104). The generation of the graph may be executed for each variable (e.g., accepted input data) based on the configuration of the network, or executed based on the path of the backward propagation for each function. In other words, when there are a plurality of paths of the backward propagation, a plurality of graphs may be generated. This path can be acquired from the description of the definition of the network.

Next, the ID applicator 18 may apply or assign a backward propagation ID to each node of the generated graph based on a variable node held by an input variable (S106). When the path followed in the backward propagation in the model being the training target is different depending on the input variable, for each of the input variables, the parameters, the output variables and the like, a backward propagation ID may be applied or assigned to each path required for the backward propagation. Note that on the flowchart, the processing at S104 and the processing at S106 are separately illustrated, but the ID applicator 18 may apply the backward propagation ID concurrently with the generation of the graph at S104, based on the backward propagation ID which the variable node has. In other words, in some embodiments, the processing from S102 to S106 is not individually executed but may be executed in cooperation.

Note that as another example, the processing from S102 to S106 may be sequentially executed. For example, the forward propagation may be performed in the order of S102, S104, S106 to generate a graph and apply an ID, or the processing at S104 and the processing at S106 may be executed in combination after S102, namely, the generation of the graph and ID application may be executed in combination after the completion of the forward propagation. Alternatively, S102 may be performed after S104, namely, the forward propagation may be performed after the graph for the backward propagation is generated. As explained above, the processing from S102 to S106 is applicable to any implementation as long as it can acquire the result subjected to the forward propagation, generate a graph for each path of the backward propagation, and apply the backward propagation ID.

Next, the backward propagator 20 may execute the error backward propagation processing based on the applied backward propagation ID (or IDs) (S108). Further, the backward propagator 20 may discard the graph data, for example, the node for which the operation has been finished and to which the backward propagation ID required for subsequent operation is not applied, after the error backward propagation processing based on the backward propagation ID is finished (S110). As another example, the backward propagator 20 may discard the node which is not reused while executing the error backward propagation. When there is a reference relationship between graphs, the backward propagator 20 may decide the order of the backward propagation and may execute the backward propagation processing in the order.

Next, the backward propagator 20 may branch the processing depending on whether there is a graph which has not been subjected to backward propagation, namely, a graph which has not been discarded (S112). When there is a graph which has not been discarded (S112: NO), it may be determined that the backward propagation has not been finished yet, so the backward propagator 20 may execute the error backward propagation on the graph which has not been discarded (S108 to S110).

For example, after the backward propagation of the graph with the backward propagation ID1 and the discard of the graph are finished, the processing of the graph with the backward propagation ID2 may be subsequently executed. The branching in this flowchart is illustrated merely as an example and does not need to be dynamically formed. The branching in this flowchart is illustrated to indicate execution of the backward propagation of all of the generated graphs and the discard of the graphs.

Further, as indicated with the broken line, after the backward propagation using a certain graph is finished, other forward propagation processing may be executed. In this case, after the processing of the certain graph, the forward propagation regarding another backward propagation ID may be executed, a graph may be generated, and the backward propagation may be performed (S102 to S110). As explained above, other forward propagation processing and graph generation processing may be performed after the backward propagation processing.

Furthermore, complicated processing may be performed in which, for example, (1) the forward propagation of the backward propagation ID1, ID2, (2) the execution of the graph generation, (3) the backward propagation of the backward propagation ID1, (4) the discard of the graph, (5) the forward propagation of the backward propagation ID3, (6) the graph generation, then (7) backward propagation of the backward propagation ID2, and (8) the discard of the graph are executed. The order of the processing may be uniquely decided and executed when, for example, the forward propagation processing based on the input variable is defined based on the description of the network definition as explained above and the forward propagation is started to be executed. As another example, the branching of further forward propagation processing may exist at the timing of the start of the subsequent forward propagation processing. As explained above, the processing at S102 to S112 can be properly executed on any processing executed by the general Define-by-Run scheme.

In other words, the descriptions of the processing from S102 to S110 in the flowchart are arranged in order merely as an example, and the processing of the forward propagation and the graph generation, the backward propagation, and the discard of graph may be executed in order for each path of the backward propagation, and sequential execution of the processing having the same backward propagation ID is not required. As explained above, the processing for the backward propagation ID1 may be sequentially performed in order, whereas the processing for the backward propagation ID2 and the processing for the backward propagation ID3 do not need to be sequentially performed in order for each ID. In a further complicated case, the order of the processing can be similarly appropriately changed.

On the other hand, when all of the graphs have been discarded (S112: YES), it is determined whether the training has been finished (S114). The finish of the training is determined, as with the general learning, by the end condition that the training for a predetermined number of epochs has been performed, the value of the loss has become smaller than a predetermined value, the accuracy has become larger than a predetermined value, or the like.

When the training has not been finished yet (S114: NO), a new graph may be generated for a new input variable (S102), and the processing of the training may be repeated (S104 to S112).

On the other hand, when the training has been finished (S114: YES), the result may be output and stored (S116), and the training processing may be ended.

As explained above, according to this embodiment, it becomes unnecessary to save the information on the generated graph until the backward propagation is performed for all of the variables, functions, and so on, thereby enabling higher efficiency for use of the memory while performing the processing by Define-by-Run. More specifically, capability of use of a plurality of graphs makes it possible to more clearly and finely control a portion to be saved and a portion not to be saved in the graph for calculation of the error backward propagation, thereby achieving higher efficiency of the memory.

For example, in the case where the graph has a plurality of paths such as differentiation performed two or more times on the operation node in the error backward propagation, the training can be performed more efficiently. This can be used also for the case of not calculating the gradient with respect to the input in the error backward propagation for the loss function although in other embodiments, the gradient with respect to the input is calculated in the error backward propagation executed for the loss function. By generating and discarding the graph as explained above, it becomes possible to discard the graph becoming unnecessary to thereby release the memory area used for the graph, at the timing when the error backward propagation is completed for some of the variables.

An example of the graph generation has been explained in FIG. 2, and other different examples are explained below. In any of the cases, the flow of the whole processing is the same as that in the above-explained flowchart.

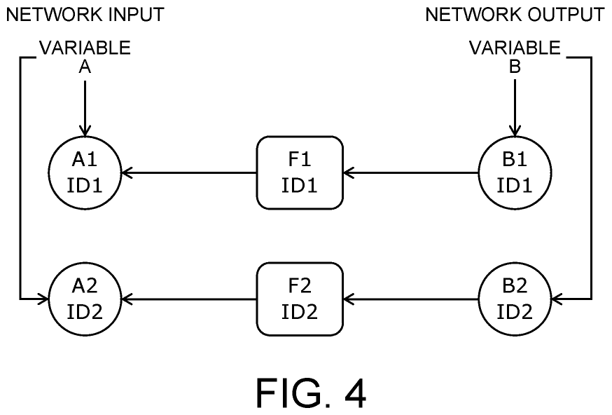

FIG. 4 is a chart illustrating graph generation in the case where the variable A has two nodes at the input node. For example, in the calculation of B=F(A), when the variable A has two nodes A1, A2, the operation nodes corresponding to the nodes A1, A2 are generated in the backward propagation as in FIG. 4. In the following chart, a solid line indicates the edge of the graph, and a one-dotted chain line indicates the node generation from the variable or the like.

For the variable A, a graph having nodes A1, F1, B1 and the backward propagation ID1 applied to each of the nodes, and a graph having nodes A2, F2, B2 and the backward propagation ID2 applied to each of the nodes may be generated. More specifically, in the forward propagation, the variable B is output by the operation F. Then, when there are two paths of the backward propagation, the graph of the backward propagation ID1 including the nodes A1, F1, B1, and the graph of the backward propagation ID2 including the nodes A2, F2, B2 may be generated based on the paths of the backward propagation as illustrated in FIG. 4.

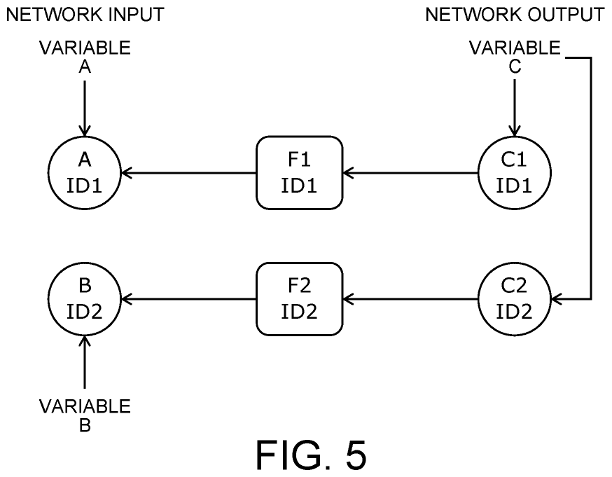

FIG. 5 is a chart illustrating the graph generation in the case where when two variables are input, one variable is output. This is the case of, for example, the operation where two arguments such as C=F(A, B) are needed.

In this case, when A and B have variable nodes having different backward propagation IDs, the operation nodes corresponding to the backward propagation IDs may be generated and variable nodes C1, C2 corresponding to all of the operation nodes may be generated for the output variable C. For example, the error backward propagation processing may be executed in the operation node F1 from a variable node C1 being the output for the variable A, whereas the error backward propagation processing may be executed in the operation node F2 from a variable node C2 being the output for the variable B.

As explained above, for outputs from separate variables and the same or different operations, graphs to which separate backward propagation IDs are applied can be generated.

The case where the variables have different nodes but the operation node is connected only from one path of each variable has been explained in all of the above-explained examples but, not limited to this, there also is, for example, a case where there is connection to different input variable nodes from the same operation node.

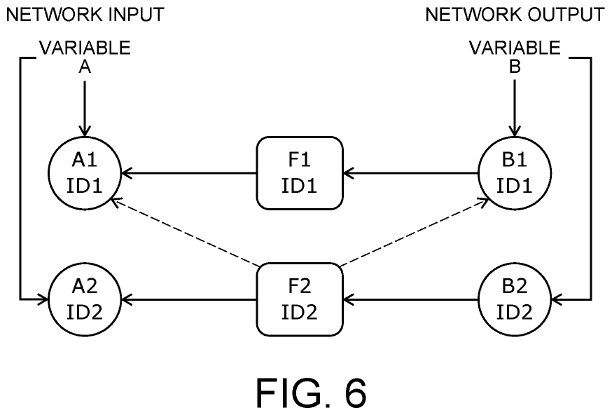

FIG. 6 illustrates the graph generation in the case where a plurality of input nodes and output nodes are connected with one operation node. As one example, the case of referring to the input node and the output node in the operation of B=F(A) is explained. In the following chart, the broken line indicates a reference relationship. For example, the graph generator 14 may make setting based on the backward propagation path so that the nodes have the reference relationship.

The backward propagation ID1 may be applied to the variable nodes A1, B1 and the operation node F1, and the backward propagation ID2 may be applied to the variable nodes A2, B2 and the operation node F2. However, in the operation of the operation node F2, the variables of the variable nodes A1, B1 may be used, and therefore the reference relationships (broken arrows in the chart) to the variable nodes A1, B1 may be further given to the operation node F2.

In such a case, the backward propagator 20 may execute the operation from the graph of the backward propagation ID having the node referred to. The example in FIG. 6 is explained. There are two graphs having the backward propagation ID1, ID2, and the operation node F2 to which the backward propagation ID2 is applied has a reference to the variable nodes A1, B1 to which the backward propagation ID1 is applied.

In this case, the backward propagator 20 may start operation from the graph relating to the backward propagation ID2. First, the backward propagator 20 may calculate the loss in the variable node B2, and calculate the gradient based on the backward propagated loss in the operation node F2. For example, the variables A1, B1 are used for the calculation of the gradient. Only one operation node is indicated as in the above, but there may be a plurality of operation nodes. Further, the variables A1, B1 may be used for the calculation of the gradient for a certain operation node, the variables A1, B1 may be used for the calculation of the gradient for different operation nodes, respectively, or they may be used in combination. Similar operations may be performed even when there are three or more input/output variables.

After the backward propagator 20 calculates the gradient of the operation node F2, executes the error backward propagation processing up to the variable node A2, and finishes the error backward propagation of the graph regarding the backward propagation ID2, the backward propagator 20 may discard the graph having each of the nodes to which the backward propagation ID2 is applied. Thereafter, the backward propagator 20 may execute the error backward propagation processing regarding the backward propagation ID1.

By giving the reference relationship as explained above, the usage efficiency of the memory can be improved by execution of the generation and discard of the graph also when there is a mutual relationship between variable nodes, between operation nodes, or between variable nodes and operation nodes between a plurality of graphs. As for the order of performing the backward propagation processing (operation), for example, the backward propagator 20 may extract the reference relationship in each of the graphs and decide the order based on the extracted result.

When the operation of differentiation depends on the variable node of another backward propagation ID, the calculation of the differentiation itself may be stored in advance using the operation node and the variable node as with the calculation of the general backward propagation, and the operation may be performed based on the reference relationship.

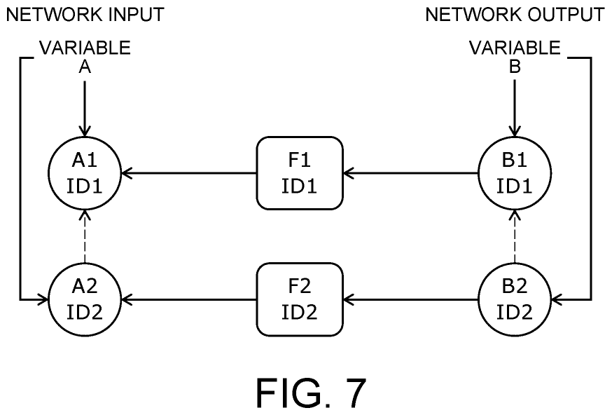

Note that, as in FIG. 7, the reference relationship may be given to the variable nodes. As another example, the variable node indicating the reference relationship may be provided in each of the graphs, and the reference relationship from the node in another graph or the node into the other graph may be stored in advance, and the reference to the variable node may be confirmed at the timing when executing the backward propagation, thereby performing the backward propagation in the order capable of efficiently discarding the graph. For example, the reference relationship to the node having another backward propagation ID may be confirmed, and the backward propagation may be executed from the graph having the reference to the other graph.

As another example, a reference graph indicating the reference relationship may be further provided, and the operation may be executed from a graph having a backward propagation ID corresponding to a node being the end of the reference graph. This makes it possible to easily apply the operation according to this embodiment also to the case of having a plurality of graphs whose reference relationship becomes complicated.

The reference relationship is given to the graph referring to the node of another graph, but conversely, the relationship having the node referred to from the other graph may be stored together with the graph. In this case, execution of the operation of the backward propagation from the node appropriately referred to as in the above makes it possible to sequentially discard information starting from the information on the graph for which the operation has been finished.

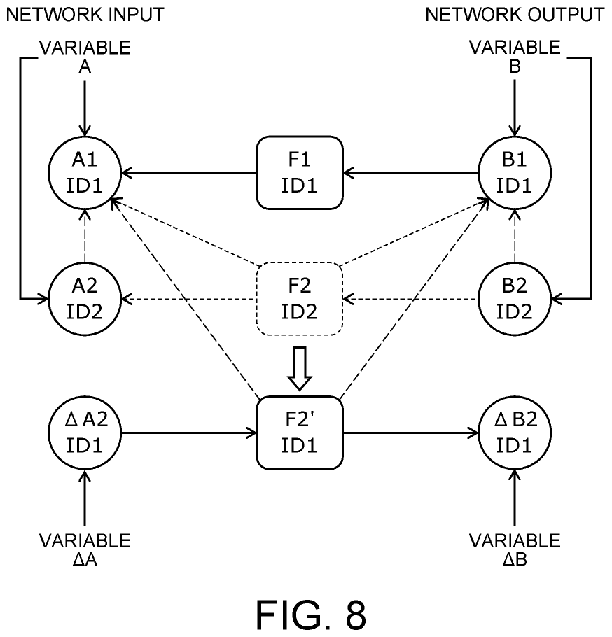

FIG. 8 illustrates an example of the graph generation in a more complicated case. The relationship between input/output and the operation is assumed to be B=F(A) as in the above. Further, differentiation F′ of the operation F is assumed to be a calculation using input/output variables A, B. In FIG. 8, dotted lines indicate the discarded node and edge.

First, in the graph generation, the variable nodes A1, B1 are referred to from the operation node F2. AB represents the gradient with respect to the variable B obtained as a result in the midway of the error backward propagation, and AA represents the gradient with respect to the variable A obtained as a result of the error backward propagation with respect to the operation F. FIG. 8 illustrates the case of having the node to which the backward propagation ID1 is applied about AB.

The backward propagation processing may be executed from the graph to which the backward propagation ID2 is applied. Upon calculation of differentiation F2′ of F2, the backward propagation ID1 may be applied to the operation node of F2′. Then, a reference to the variable nodes A1, B1 may be made from the operation node F2′. Then, the variable node B2, the operation node F2, and the variable node A2 for which the backward propagation has been finished may be discarded.

When there is a node depending on another graph as in the above, the generation of the node transmitting input of the variable to which the backward propagation ID is applied can discard the graph as in the above for each path of the backward propagation. After the completion of the error backward propagation of the node which is referred to, the variable node and the operation node to which the backward propagation ID is applied may be discarded and, in particular, the resource which is not shared with the operation node of another backward propagation ID among the resources saved by the operation node may be discarded or released. On the other hand, for the error backward propagation for the calculation graph of the other backward propagation ID, correct operation can be performed, for example, by saving the operation node F2′.

Some examples of a simple case have been explained in this embodiment. By generating a graph, applying a unique backward propagation ID to the node for each generated graph, and giving a reference relationship between nodes to which different backward propagation IDs are applied if necessary, the resource can be released sequentially from the calculation graph for which the backward propagation has been completed. This is similarly applicable to a graph which is more complicated than the above-explained one.

As explained above, in some embodiments, in the case of backward propagation of a network, a graph is not generated for the whole network, but a graph is generated based on a path of the backward propagation, thereby improving the usage efficiency of the resource. This can achieve higher efficiency of the memory also in the Define-by-Run scheme of performing a complicated operation.

In the training apparatus 1 according to some embodiments, each function may be implemented by a circuit constituted by an analog circuit, a digital circuit, or an analog/digital mixed circuit. A control circuit which controls each function may be included in the training apparatus 1. Each circuit may be implemented as an ASIC (application specific integrated circuit), an FPGA (field programmable gate array), or the like.

In all of the foregoing explanations, at least a part of the training apparatus 1 may be constituted by hardware, or by software and a Central Processing Unit (CPU) or the like may implement the function through information processing of the software. When it is constituted by software, programs that enable the training apparatus 1 and at least a part of the functions may be stored in storage media, such as a flexible disk and a CD-ROM, and may be executed by being read by a computer. The storage media are not limited to detachable media such as a magnetic disk or an optical disk, and may include fixed storage media such as a hard disk device and a memory. That is, the information processing may be concretely implemented using hardware resources. For example, the processing may be implemented on a circuit such as the FPGA, and may be executed by hardware. The generation of the models and the subsequent processing of the model input may be performed by using, for example, an accelerator such as a Graphics Processing Unit (GPU).

For example, a computer may be programmed to act according to the above embodiments by dedicated software stored in a computer-readable storage medium. The kinds of storage media are not limited. The computer may be used to implement a device according to the embodiment by installing dedicated software on the computer, e.g., by downloading the software through a communication network. The information processing is thereby concretely implemented using hardware resources.

FIG. 9 is a block diagram illustrating an example of a hardware configuration according to some embodiments of the present disclosure. The training apparatus 1 may include a computing device 7 having a processor 71, a main storage 72, an auxiliary storage 73, a network interface 74, and a device interface 75, connected through a bus 76.

Although the computing device 7 shown in FIG. 9 includes one of each component 71-76, a plurality of the same components may be included. Moreover, although one computing device 7 is illustrated in FIG. 9, the software may be installed into a plurality of computing devices, and each of the plurality of computing devices may execute a different part of the software process.

The processor 71 may be an electronic circuit (processing circuit) including a control device and an arithmetic logic unit of the computer. The processor 71 performs arithmetic processing based on data and programs input from each device or the like of an internal configuration of the computing device 7, and outputs arithmetic operation results and control signals to each device or the like. For example, the processor 71 may control each component constituting the computing device 7 by executing an OS (operating system), applications, and so on, of the computing device 7. The processor 71 is not limited to a particular processor and may be implemented by any processor capable of performing the above-stated processing.

The main storage 72 stores instructions executed by the processor 71, various data, and so on, and information stored in the main storage 72 may be directly read by the processor 71. The auxiliary storage 73 is a storage other than the main storage 72. These storages may be implemented using arbitrary electronic components capable of storing electronic information, and each may be a memory or a storage. Both a volatile memory and a nonvolatile memory can be used as the memory. The memory storing various data in the training apparatus 1 may be formed by the main storage 72 or the auxiliary storage 73. For example, at least one of the storage for the training apparatus 1 may be implemented in the main storage 72 or the auxiliary storage 73. As another example, at least a part of the storage may be implemented by a memory which is provided at the accelerator, when an accelerator is used.

The network interface 74 is an interface to connect to a communication network 8 through a wire or wireless interface. An interface which is compatible with an existing communication protocol may be used as the network interface 74. The network interface 74 may exchange information with an external device 9A which is in communication with computing device 7 through the communication network 8.

The external device 9A may include, for example, a camera, a motion capture device, an output destination device, an external sensor, an input source device, and so on. The external device 9A may be a device implementing a part of the functionality of the components of the training apparatus 1. The computing device 7 may transmit or receive a part of processing results of the training apparatus 1 through the communication network 8, like a cloud service.

The device interface 75 may be an interface such as a USB (universal serial bus) which directly connects with an external device 9B. The external device 9B may be an external storage medium or a storage device. At least part of the storage may be formed by the external device 9B.

The external device 9B may include an output device. The output device may be, for example, a display device to display images, and/or an audio output device to output sounds, or the like. For example, there external device may include an LCD, (liquid crystal display), a CRT (cathode ray tube), a PDP (plasma display panel), a speaker, and so on. However, the output device is not limited to these examples.

The external device 9B may include an input device. The input device may include devices such as a keyboard, a mouse, a touch panel, or the like, and may supply information input through these devices to the computing device 7. Signals from the input device may be output to the processor 71.

While certain embodiments have been described, these embodiments have been presented by way of example only, and are not intended to limit the scope of the present disclosure. Various additions, modifications, and partial deletion may be made within a range not departing from the conceptual idea and the spirit of the present disclosure which are derived from contents stipulated in the accompanying claims and their equivalents. For example, in all of the above-stated embodiments, numeric values used for the explanation are each presented by way of an example, and not limited thereto. Moreover, while certain processes and methods have been described as a series of steps, it is to be understood that the performance of these steps is not limited to the order described and that non-dependent steps may be performed in any order, or in parallel.

1. A training apparatus comprising:
one or more memories; and
one or more processors configured to:
generate a graph based on a path of an error backward propagation;
assign an identifier based on the path of the error backward propagation; and
execute the error backward propagation based on the graph and the identifier.

2. The training apparatus according to claim 1, wherein
the one or more processors are configured to generate nodes representing the path of the error backward propagation, the nodes corresponding to an input variable, an operation in forward propagation, and an output variable, respectively.

3. The training apparatus according to claim 1, wherein the one or more processors are configured to:
determine if there are a plurality of different paths of the error backward propagation, and
generate, in response to determining that a plurality of different paths of the error backward propagation exists, a plurality of the graphs indicating respective ones of the plurality of different paths.

4. The training apparatus according to claim 1, wherein
the one or more processors are configured to uniquely assign the identifier to one or more nodes for each of graphs having the same path of the error backward propagation.

5. The training apparatus according to claim 4, wherein
the one or more processors are configured to assign different identifiers to nodes belonging to graphs having different paths of the error backward propagation.

6. The training apparatus according to claim 1, wherein
the one or more processors are configured to:
execute the error backward propagation for nodes to which the same identifier is assigned; and
discard data on the graph to which the identifier is assigned upon completion of the error backward propagation for the identifier.

7. The training apparatus according to claim 1, wherein
the one or more processors are configured to:
determine if there is a reference relationship between nodes having different identifiers;
generate, in response to determining that there is a reference relationship between nodes having different identifiers, a node having the reference relationship; and
decide an order of the graph for which the error backward propagation is performed based on the reference relationship.

8. The training apparatus according to claim 1, wherein
the one or more processors are configured to assign the identifier to each node of the graph based on the path of the error backward propagation in the graph.

9. A training method comprising:
generating, by one or more processors, a graph based on a path of an error backward propagation;
assigning, by the one or more processors, an identifier based on the path of the error backward propagation; and
executing, by the one or more processors, the error backward propagation based on the graph and the identifier.

10. The training method according to claim 9, further comprising:
generating nodes representing the path of the error backward propagation, the nodes corresponding to an input variable, an operation in forward propagation, and an output variable, respectively.

11. The training method according to claim 9, further comprising:
determining if there are a plurality of different paths of the error backward propagation, and
generating, in response to the determining that a plurality of different paths of the error backward propagation exists, a plurality of the graphs indicating respective ones of the plurality of different paths.

12. The training method according to claim 9, wherein
assigning the identifier based on the path of the error backward propagation includes uniquely assigning the identifier to one or more nodes for each of graphs having the same path of the error backward propagation.

13. The training method according to claim 12, wherein
different identifiers are assigned to nodes belonging to graphs having different paths of the error backward propagation.

14. The training method according to claim 9, further comprising:
executing the error backward propagation for nodes to which the same identifier is assigned; and
discarding data on the graph to which the identifier is assigned upon completion of the error backward propagation for the identifier.

15. The training method according to claim 9, further comprising:
determining if there is a reference relationship between nodes having different identifiers;
generating, in response to determining that there is a reference relationship between nodes having different identifiers, a node having the reference relationship; and
deciding an order of the graph for which the error backward propagation is performed based on the reference relationship.

16. The training method according to claim 9, wherein assigning the identifier based on the path of the error backward propagation includes assigning the identifier to each node of the graph based on the path of the error backward propagation in the graph.

17. A non-transitory computer readable medium storing a program instructions for causing one or more processors to:
generate a graph based on a path of an error backward propagation;
assign an identifier based on the path of the error backward propagation; and
execute the error backward propagation based on the graph and the identifier.

18. The non-transitory computer readable medium according to claim 17, wherein the one or more processors are caused to assign the identifier to each node of the graph based on the path of the error backward propagation in the graph.

19. A model generating method comprising:
generating, by one or more processors, a graph based on a path of an error backward propagation;
assigning, by the one or more processors, an identifier based on the path of the error backward propagation;
executing, by the one or more processors, the error backward propagation based on the graph and the identifier; and
obtaining, by the one or more processors, parameters of a trained model based on the error backward propagation.

20. The model generating method according to claim 19, further comprising:
storing, by the one or more processors, the generated model in one or more memories.
